(19) United States
(12) Patent Application Publication
(10) Pub. No.: US 2026/0088970 A1
(43) Pub. Date: Mar. 26, 2026

(54) Hybrid AI Failover and Secure Field-Data Capture System with Shadow-Mode Validation and Training-to-Inference Reassignment

(71) Applicant: Joshua A Wright, Wichita, KS (US)

(72) Inventor: Joshua A Wright, Wichita, KS (US)

(21) Appl. No.: 19/398,083

(22) Filed: Nov. 24, 2025

Related U.S. Application Data
(63) Continuation-in-part of application No. 19/291,598, filed on Aug. 6, 2025.
(63) Continuation-in-part of application No. 19/280,126, filed on Jul. 25, 2025.

(51) Int. Cl. H04L 9/00; G06F 11/20

(52) U.S. Cl. CPC H04L 9/006; G06F 11/2023; H04L 9/50; G06F 2201/85

(57) ABSTRACT

A hybrid artificial intelligence (AI) failover system is disclosed for safety-critical computing environments. A primary AI model and a candidate AI model are executed in parallel, with candidate outputs evaluated in shadow mode. A divergence analysis module and inference-authority gating logic govern controlled transfer of inference authority only when alignment criteria are satisfied over a validation interval. Upon detection of failure, drift, or anomaly, inference authority is reassigned during a controlled transition window to reduce output discontinuity or system instability. The system supports secure audit logging, encrypted data handling, and deployment in connected or air-gapped environments.

### CROSS-REFERENCE TO RELATED APPLICATIONS

This application is a continuation-in-part of:
1. U.S. Application No. Ser. No. 19/280,126, titled Secure Field-Data Capture and AI-Assisted Asset Management, and
2. U.S. Application No. Ser. No. 19/291,598, titled Hybrid AI Failover System With Dynamic Training-to-Inference Reassignment and Shadow-Mode Gated Promotion.

The contents of both are incorporated herein by reference in their entirety.

This continuation provides the bridging architecture that unifies on-device failover AI with secure field-data capture platforms and compliance-driven mobile/edge AI systems.

### TECHNICAL FIELD

The invention relates to artificial intelligence systems for secure, compliance-driven, and safety-critical environments. More specifically, it concerns systems and methods integrating hybrid AI failover, shadow-mode model validation, and training-to-inference compute reassignment with secure mobile field-data capture, diagram ingestion, and structured extraction of engineering and industrial asset information.

### BACKGROUND

Critical infrastructure organizations-including utilities, industrial facilities, defense installations, and data centers-depend on accurate field asset information and reliable on-device AI for extraction and structuring of engineering data. Existing approaches suffer from a series of deficiencies:
Lack of validated model promotion:
   Conventional systems deploy new or updated models without performing controlled, parallel comparison against the active production model.
No hybrid training-to-inference failover:
   Existing AI architectures do not dynamically reassign a training compute unit to inference when the primary inference unit fails or produces anomalous output.
Absence of shadow-mode validation:
   Prior systems do not execute new models in parallel (“shadow mode”) to verify alignment before promotion.
Insufficient secure field-data capture:
   Current tools do not support encrypted, compliance-ready, offline workflows for capturing equipment images and engineering diagrams.
Inability to maintain reliable extraction under thermal throttling or hardware degradation in air-gapped environments:
   Field devices often operate in harsh conditions without reliable network support, causing degradation that existing systems cannot mitigate.
Lack of immutable audit trails required for compliance:
   Regulatory frameworks such as NERC-CIP, CMMC, SOC 2, and ISO 27001 require tamper-evident logs and model-provenance tracking, which legacy systems do not provide.

There remains an unmet need for a single, unified system that supports secure field-data capture and validated, resilient AI operation with comprehensive failover and compliance mechanisms.

### SUMMARY OF THE INVENTION

This continuation-in-part introduces an integrated system that embeds the hybrid AI failover architecture of parent application Ser. No. 19/291,598 within the secure field-data capture platform of parent application Ser. No. 19/280,126. The resulting system sustains continuous, validated extraction of engineering diagrams, equipment images, and nameplate data while providing secure offline operation.

The system enables:
1. On-device extraction including OCR, topology recognition, and nomenclature parsing;
2. Candidate model execution in shadow mode;
3. Threshold-gated model promotion without cloud connectivity;
4. Automatic fallback to validated standby models when performance degrades;
5. Secure, compliance-ready operation with encrypted storage, signed models, hash-chained logs, and NIST/post-quantum synchronization pathways;
6. Continuous, reliable operation in thermal, hardware-degraded, or air-gapped environments.

This bridging continuation integrates field-data capture and AI failover technologies so that extraction workflows benefit from model validation, compute reassignment, and promotion gating. Likewise, the failover architecture is enhanced to operate in industries where accuracy, traceability, and immutability are essential. The detailed description of the hybrid AI failover subsystem, including the primary inference compute unit, training-to-inference reassignment controller, shadow-mode validation logic, divergence analyzer, and output-gating module, is set forth in the incorporated parent application Ser. No. 19/291,598 at paragraphs [0008]-[0018] and FIGS. 2-4 thereof. The entire hybrid failover and validation process, including shadow-mode execution, divergence comparison, threshold-gated promotion, compute-unit reassignment, and output gating, operates autonomously on the mobile field-data capture device without requiring any cloud connectivity or external network access at any stage.

### BRIEF DESCRIPTION OF THE DRAWINGS

FIG. 1 illustrates a unified system architecture (100) including a mobile field-data capture device (110), an image-capture subsystem (112), a diagram-ingestion module (114), a hybrid failover AI stack (200) comprising a hybrid extraction pipeline (210) executed on a primary inference compute unit (122) and a training compute unit (124) with a passive backup storage region (126), as well as a secure data queue (500) and synchronization interface (530).

FIG. 2 illustrates a hybrid extraction pipeline (210) including an active extraction model (212), a candidate shadow-mode model (214), and a divergence analyzer (216). The figure further depicts a divergence-threshold gate (310), an alignment-evaluation module (320), and a validation-result controller (340) used to determine whether the candidate model meets promotion criteria.

FIG. 3 illustrates shadow-mode validation logic (300) including a controller (302), a divergence-threshold gate (310), and an alignment-evaluation module (320) used to determine whether a candidate model may be safely promoted.

FIG. 4 illustrates a failover flow (400) beginning with anomaly detection (440), followed by a training-to-inference reassignment controller (410), a standby-model loader (420), and an output-gating module (430), after which the system resumes inference (450) using the validated standby model.

FIG. 5 illustrates a secure data-queue architecture (500) including an encryption module (510), a hash-chaining module (520), model-version metadata (522), promotion/failover logs (524), hash identifiers (526), and a synchronization interface (530).

FIG. 6 illustrates an immutable/WORM audit-logging architecture (600) including an event recorder (610), a model-provenance tracker (620), a tamper-evident log chain (630), a digital-signature module (640), and an append-only WORM store (650).

FIG. 7 illustrates deployment examples (700) including field-robotics platforms (710), utility-sector systems (720), industrial-facility environments (730), and government or defense systems (740).

### DETAILED DESCRIPTION

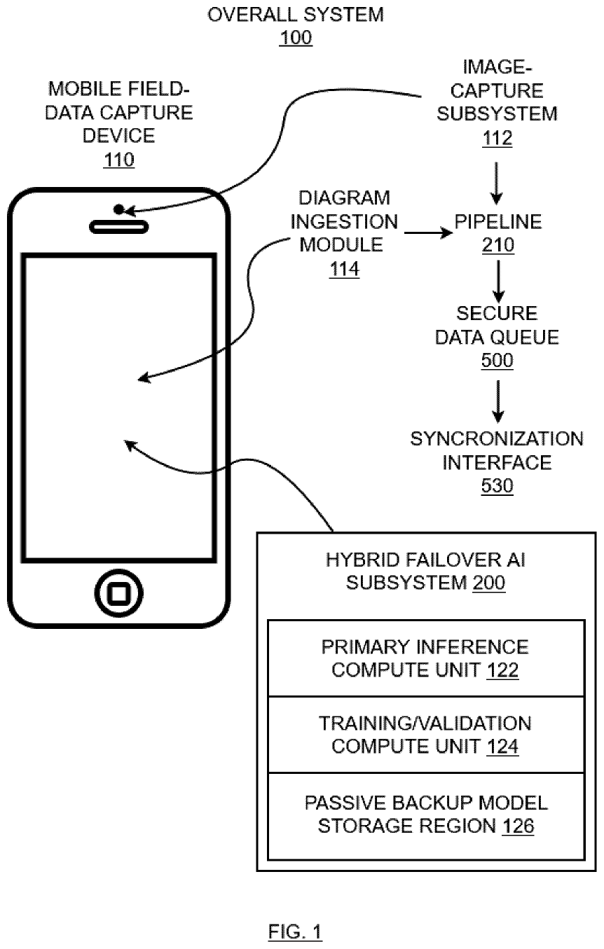

### 1. Unified Mobile Field Device Architecture (FIG. 1)

The system (100) includes a secure mobile or fixed field-data capture device (110) having an image-capture subsystem (112) for photographing equipment, nameplates, and diagrams, and a diagram-ingestion module (114) configured to parse one-line diagrams, engineering symbols, and structural relationships. The device further incorporates a hybrid failover AI stack (200) that includes a primary inference compute unit (122), a training compute unit (124), a passive backup storage region (126) holding validated standby models, and a hybrid extraction pipeline (210) operating across the compute units. The system additionally provides a secure data queue (500) for encrypted local storage of extracted information and a synchronization interface (530) for secure or air-gapped transmission of stored data.

The device supports full offline operation, with asset records retained locally in encrypted form until synchronization pathways are available.

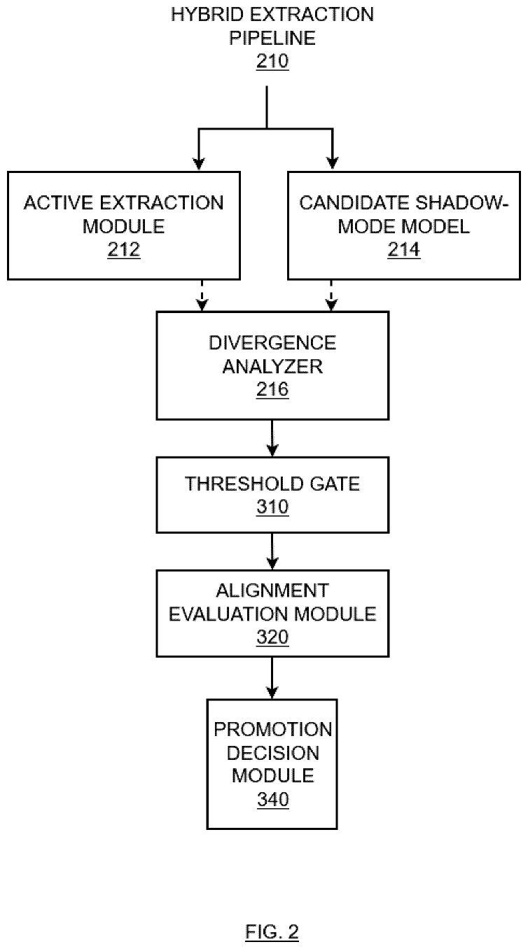

### 2. Hybrid Failover Extraction Pipeline (FIG. 2)

The hybrid extraction pipeline (210) includes an active extraction model (212) that performs OCR, structured text parsing, topology detection, and nomenclature extraction, and a candidate shadow-mode model (214) that receives identical inputs in parallel and produces outputs analyzed by a divergence analyzer (216). Validation thresholds (310) define acceptable deviation ranges, while an alignment-evaluation module (320) further assesses consistency across extracted fields. A promotion-decision module (340) determines whether the candidate model satisfies the criteria for promotion to active inference.

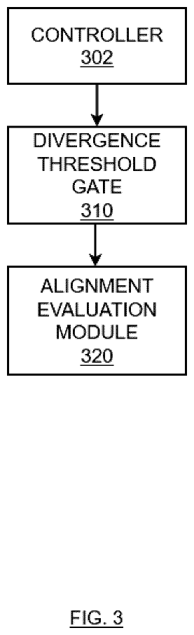

### 3. Shadow-Mode Validation Logic (FIG. 3)

The shadow-mode validation logic (300) evaluates whether a candidate extraction model should be promoted to active use. A controller (302) receives outputs from both the active extraction model and the candidate model and applies a divergence threshold gate (310) to detect unsafe deviation. When divergence remains within an acceptable range, an alignment-evaluation module (320) assesses consistency across entity boundaries, topology outputs, and structured extraction fields. This validation pathway ensures that model promotion occurs only when the candidate model demonstrates stable, safe, and predictable output behavior under identical inputs.

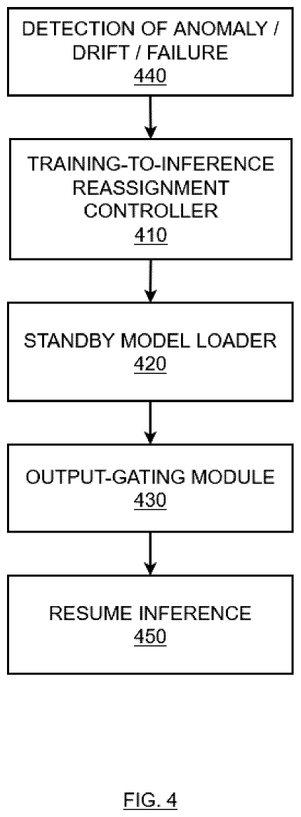

### 4. Failover Handling (FIG. 4)

When the active extraction model (212) fails, drifts, exceeds latency limits, produces anomalous patterns, or misinterprets engineering attributes, the system (400) initiates a failover sequence. An output-gating module (430) is first activated to close the output path, suppress unsafe outputs, and optionally route workflows to human-in-the-loop validation. A reassignment controller (410) then transitions the training compute unit (124) to inference mode, and a standby loader (420) retrieves a validated standby extraction model from the passive backup storage region (126). Once the standby model is active and stable, a resume-inference stage (450) restores normal processing, during which the output-gating module (430) re-opens to permit safe extraction output.

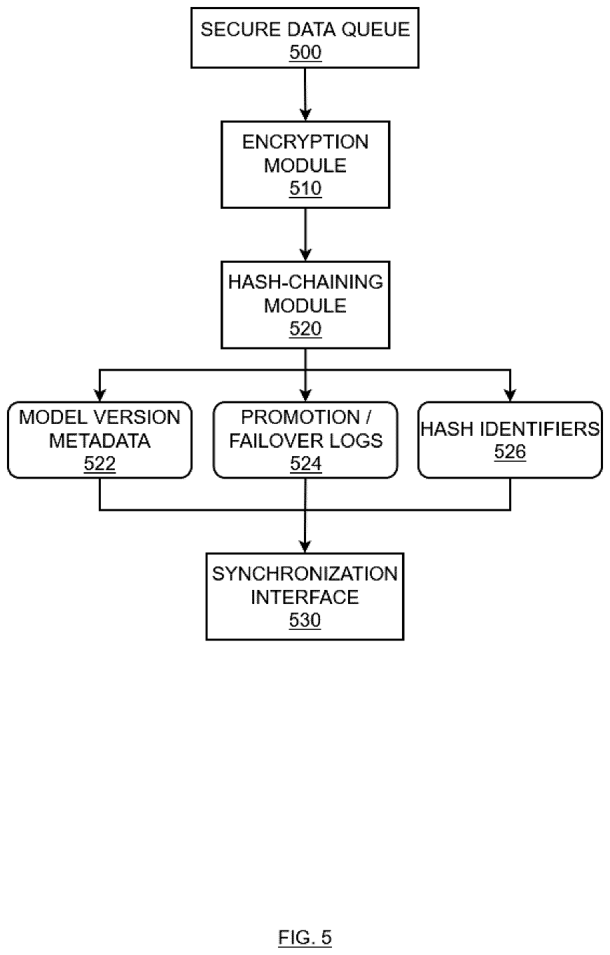

### 5. Secure Data Queue and Audit Integration (FIG. 5)

All extracted data is first placed into a secure data queue (500) where it is encrypted using an encryption module (510), committed to a hash-chained structure through a hash-chaining module (520), and annotated with model-version metadata (522), promotion logs (524), and hash identifiers (526). The data remains stored locally until a synchronization interface (530) becomes available, at which point the encrypted asset records and tamper-evident logs are transmitted to a backend system using TLS 1.3 or NIST-approved post-quantum cryptographic protocols for connected deployments, or through hash-validated out-of-band mechanisms-including removable media, secure wired links, optical transfer, or near-field exchange-for air-gapped environments.

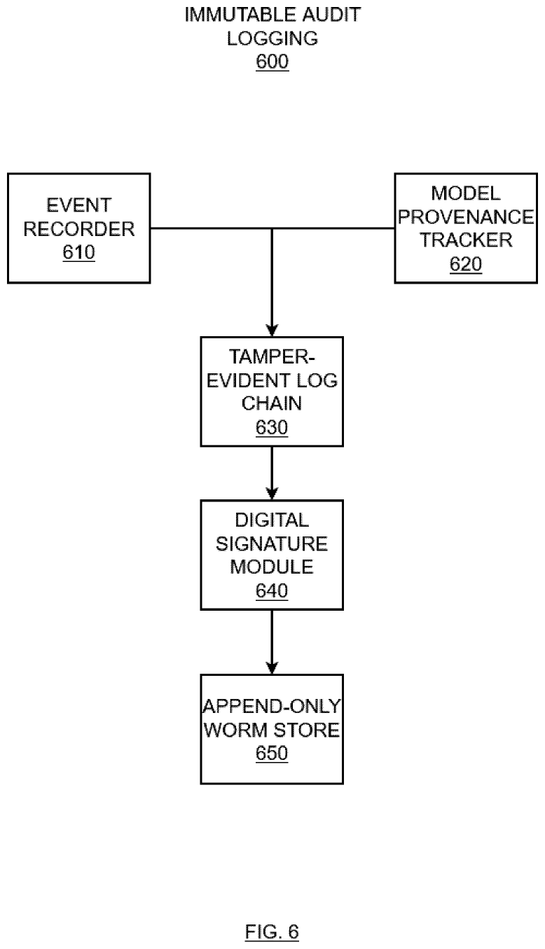

### 6. Compliance and Audit Logging (FIG. 6)

The compliance and audit-logging architecture (600) records each operational event-including failover, model promotion, shadow-mode comparison, extraction, and synchronization-using an event recorder (610), a model-provenance tracker (620), and a tamper-evident log chain (630). These components feed a digital-signature module (640) configured to apply PKI-based signatures to each log entry before the entry is stored in an append-only WORM store (650). This audit pipeline enables compliance with regimes such as NERC-CIP, CMMC, SOC 2, ISO 27001, and IEC 62443 by ensuring that model-related and extraction-related operations are captured in an immutable, cryptographically verifiable record.

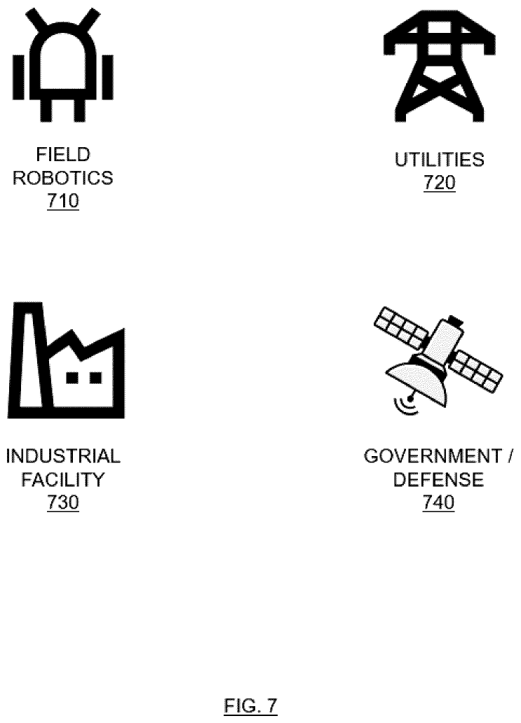

### 7. Deployment Examples (FIG. 7)

FIG. 7 illustrates non-limiting deployment examples (700) showing representative environments in which the secure field-capture architecture and hybrid failover subsystem may operate. These include (710) field-robotics platforms executing autonomous or semi-autonomous extraction tasks; (720) utility-sector assets such as substations, transmission infrastructure, or distributed-energy systems; (730) industrial-facility environments requiring compliant asset logging and on-device failover; and (740) government or defense systems incorporating secure, tamper-evident promotion and audit controls. These examples are illustrative only, and the system may be deployed in any environment requiring secure on-device extraction, local failover, shadow-mode validation, or compliance-grade audit logging.

1-10. (canceled)

11. A system comprising:
a computing system configured to operate in a safety-critical environment;
a primary inference compute unit executing a primary artificial intelligence (AI) model to generate inference outputs;
a secondary compute unit executing a candidate AI model in parallel with the primary AI model,
wherein the candidate AI model processes inputs functionally equivalent to those processed by the primary AI model and is prevented from producing authoritative output during parallel execution;
a divergence analysis module configured to compare outputs of the primary AI model and the candidate AI model over a validation interval;
an inference-authority gating module configured to determine eligibility for transfer of inference authority based on whether output divergence remains within a defined threshold to satisfy alignment conditions; and
a failover controller configured to govern inference-authority assignment, including revoking inference authority from the primary AI model upon detection of failure, drift, or anomaly, and assigning inference authority to the candidate AI model during a defined transition window,
wherein assignment of inference authority during the transition window is conditioned on satisfaction of divergence-based alignment criteria evaluated by the divergence analysis module and is performed in a controlled manner to reduce output discontinuity or system instability.

12. A computer-implemented method for controlling inference authority in a safety-critical system, comprising:
executing a primary artificial intelligence (AI) model on a first compute unit to generate inference outputs;
executing a candidate AI model in parallel on a second compute unit using inputs that are functionally equivalent to those used by the primary AI model following deterministic preprocessing or augmentation steps, while suppressing authoritative output from the candidate AI model;
comparing outputs of the primary AI model and the candidate AI model over a validation interval;
evaluating output divergence relative to a defined threshold to determine whether alignment conditions are satisfied;
governing inference authority by maintaining the candidate AI model in a non-authoritative state unless the divergence threshold is satisfied; and
upon satisfaction of the divergence threshold or upon detection of failure, drift, or anomaly, assigning inference authority to the candidate AI model during a transition window, including revoking inference authority from the primary AI model,
wherein inference authority is assigned in a controlled manner during the transition window that enforces output alignment to reduce output discontinuity or system instability.

13. The system of claim 11, wherein parallel execution comprises shadow-mode execution in which candidate model outputs are evaluated without influencing downstream system behavior.

14. The system of claim 11, wherein shadow-mode execution occurs during live operation without interrupting primary inference workflows.

15. The system of claim 11, wherein inference authority transfer occurs synchronously with the defined transition window to reduce output discontinuity and/or control instability.

16. The system of claim 11, wherein the divergence analysis module evaluates one or more of semantic alignment, structural consistency, temporal stability, or confidence variance.

17. The system of claim 11, wherein the secondary compute unit is dynamically reassigned from training mode to inference mode during failover.

18. The system of claim 11, further comprising a secure data queue storing records in encrypted form and associating each record with a hash-chained entry identifying at least:
(A) a version identifier of the AI model producing the record;
(B) inference-authority transfer, promotion, or failover events; and
(C) integrity metadata.

19. The system of claim 18, wherein the hash-chained entry comprises a Merkle structure, an append-only log, write-once storage, or combinations thereof.

20. The system of claim 18, further comprising a synchronization module configured to transmit encrypted records and tamper-evident logs using a secure transport.

21. The system of claim 20, wherein the secure transport comprises TLS 1.3, post-quantum cryptographic protocols, or a hash-validated out-of-band transfer mechanism for disconnected or air-gapped deployments.

22. The system of claim 11, wherein the computing system is field-deployed and operates under constrained latency, power, thermal, or connectivity conditions.

23. The system of claim 11, wherein inference outputs influence at least one of navigation, control, perception, situational assessment, or decision-making functions.

24. The method of claim 12, wherein inference-authority gating enforces deterministic behavior consistent with functional safety requirements.

25. The method of claim 12, wherein validation and inference-authority transfer occur without reliance on cloud connectivity.

26. The system of claim 11, wherein inference-authority transitions are recorded in a tamper-evident audit log suitable for compliance verification.

27. The system of claim 11, wherein a plurality of candidate AI models are executed in parallel, and wherein inference authority is transferred only after validation criteria are satisfied for at least one candidate AI model.

28. The system of claim 11, wherein, when alignment conditions are not satisfied, inference authority remains suppressed and the system is constrained to a non-authoritative degraded mode until the alignment conditions are satisfied or an authorized override condition is programmatically asserted in accordance with a predefined policy.

29. The system of claim 11, wherein, during a model promotion event that occurs while the primary AI model remains operational, if alignment conditions are not satisfied within the transition window, transfer of inference authority to the candidate AI model is not performed and inference authority remains with the primary AI model.

30. The system of claim 11, wherein the candidate AI model is maintained in a power-managed standby state on the secondary compute unit, including a dynamic voltage and frequency scaling (DVFS) state, or is inactive prior to detection of failure, drift, instability, or anomaly, and is initiated for execution, validation, or inference-authority assignment in response to a failover event.
